(19) United States
(12) Patent Application Publication
(10) Pub. No.: US 2022/0043917 A1
(43) Pub. Date: Feb. 10, 2022

(54) PROOF OF INFORMATION NOTICE IN CLIENT-SERVER SETTINGS

(71) Applicant: SAP SE, Walldorf (DE)

(72) Inventor: Benny Rolle, Karlsruhe (DE)

(73) Assignee: SAP SE, Walldorf (DE)

(21) Appl. No.: 16/989,709

(22) Filed: Aug. 10, 2020

(51) Int. Cl. G06F 21/60; G06F 21/62; G06F 21/64

(52) U.S. Cl. CPC G06F 21/602; G06F 21/645; G06F 21/6263; G06F 21/6209

(57) ABSTRACT

Systems and processes for managing information statements for service provider assets are provided herein. A request may be received from a user device to access an asset of a service provider through an application of the user device, and the service provider may send, to a statement tracking module of the user device, data corresponding to an information statement associated with the asset. The service provider may receive, from the statement tracking module of the user device, a response including an indication of user accessibility to the information statement, and store the response from the statement tracking module. Access to the asset through the application of the user device may be selectively allowed based on the response, such that access to the asset is allowed responsive to the response including a signed version of the information statement, a user identifier, and a timestamp.

### BACKGROUND

Organizations that collect personal data from individuals are typically subject to regulations or rules regarding protection and accessibility to the data. For example, the General Data Protection Regulation (GDPR) includes provisions and requirements for data controllers (e.g., the natural or legal person, public authority, agency or other body which, alone or jointly with others, determines the purposes and means of the processing of personal data, as defined in Article 4 of the GDPR). The provisions and requirements of the GDPR include protecting the rights of data subjects that correspond to collected personal data (e.g., by following principals in Article 5 of the GDPR, which may include pseudonymization of the data or other practices) and providing personal data of a particular individual to that individual if requested (e.g., in accordance with the provisions in Article 15 of the GDPR, which includes the provision that the right to obtain a copy of personal data shall not adversely affect the rights and freedoms of others). Furthermore, to remain compliant with the GDPR, an organization must be able to prove that the above provisions and requirements are fulfilled (e.g., as provisioned in Article 5 of the GDPR). One legal requirement is the provision of certain information about data processing activities. This information may include, but are not limited to, the identity of the controller, contact data of the data privacy officer, information about the personal data that are processed, the processing purposes, data subject rights etc.

One approach that organizations may take to provide such information to a data subject is by providing a data privacy statement. However, it may be difficult to prove that a data subject had access to the data privacy statement at a particular time to show GDPR compliancy. Accordingly, there remains a need for improved technologies to manage privacy statements and other informative documentation provided by organizations.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In summary, the detailed description is directed to various innovative technologies for managing, processing, and tracking the presentation of informative documentation, such as privacy statements, terms and conditions notifications, etc., to a data subject or other targeted individual (e.g., a customer, supplier, user, visitor, etc.). In some examples, the disclosed technologies can be implemented as a method performed by a computer. For example, the method may include receiving a request from a user device to access an asset of a service provider (e.g., a data controller, an online merchant, etc.) through an application of the user device, sending, to a statement tracking module of the user device, data corresponding to an information statement (e.g., informative documentation, as described above) associated with the asset, and receiving, from the statement tracking module of the user device, a response including an indication of user accessibility to the information statement. The method may further include storing the response from the statement tracking module, and selectively allowing access to the asset through the application of the user device based on the response, wherein the access to the asset is allowed responsive to the response including signed data, which includes a copy or version of the information statement, a user identifier, and a timestamp. The signed data may be cryptographically signed using a private key owned by a user associated with the user identifier.

In some examples, the disclosed technologies can be implemented as computer-readable media storing instructions which, when executed by one or more hardware processors, cause the hardware processors to perform the following actions: detecting a user request to access an asset of a service provider via an application of a user device, and determining whether an information statement associated with the asset is accessible by the user. The actions may further include, during a first condition in which the information statement is determined to be accessible by the user, sending a first notification to the service provider and allowing access to the asset via the application of the user device, the first notification including a signed information statement, a user identifier for a user requesting to access the asset, and a timestamp, and during a second condition, in which the information statement is determined to not be accessible by the user, sending a second notification to the service provider and denying access to the asset via the application of the user device, the second notification including an indication of an issue with user accessibility to the information statement.

In some examples, the disclosed technologies can be implemented in a system including one or more hardware processors with coupled memory, and computer-readable media storing instructions executable by the one or more hardware processors. The instructions include first, second, third, fourth, fifth, sixth, seventh, and eighth instructions. The first instructions, when executed, cause the system to receive data from a service provider corresponding to an asset of the service provider that is selectively accessible via an application of a user device. The second instructions, when executed, cause the system to adjust functionality of the application to deny access to the asset until an information statement is provided for access by a user of the user device. The third instructions, when executed, cause the system to determine whether the data includes a link to an information statement associated with the asset. The fourth instructions, when executed, cause the system to maintain the adjusted functionality of the application to deny access to the asset under a first condition in which the data is determined to not include the link. The fifth instructions, when executed, cause the system to present the link to the user under a second condition in which the data is determined to include the link. The sixth instructions, when executed, cause the system to retrieve, via the link, and present the information statement under the second condition responsive to detecting a selection of the link. The seventh instructions, when executed, cause the system to sign the information statement and send the signed information statement to the service provider under the second condition. The eighth instructions, when executed, cause the system to further adjust the functionality of the application to allow access of the asset responsive to sending the signed information statement to the service provider under the second condition.

The foregoing and other objects, features, and advantages of the invention will become more apparent from the following detailed description, which proceeds with reference to the accompanying figures.

### BRIEF DESCRIPTION OF THE DRAWINGS

FIG. 1 is a flowchart of an example method of dispersing an information statement associated with a service provider asset and tracking user access to the information statement.

FIG. 2 is a flowchart of an example method of providing user access to an information statement associated with a service provider asset.

FIG. 3 is a diagram schematically depicting an example system for tracking user accessibility to information statements for a service provider asset and controlling user access to the service provider asset.

FIGS. 4A and 4B show example states of a user interface for accessing a data controller asset via an application of a user device.

FIG. 5 is a diagram schematically depicting a computing environment suitable for implementation of disclosed technologies.

FIG. 6 is a diagram schematically depicting computing devices operating in conjunction with a computing cloud for implementation of disclosed technologies.

### DETAILED DESCRIPTION

Introduction and Overview

Data controllers and/or collectors are typically subject to rules and/or regulations regarding the processing of personal data (which may include the maintenance/storage of the personal data). For example, as described above, some regulations include a requirement that a data controller must provide certain information about data processing activities to a data subject (e.g., a user). In general, an organization may be considered to be in compliance with the regulations by providing this information to a data subject. For example, the regulations may not require the user to read through this information and confirm them. In other cases, additional information must be provided to the user—e.g., if the user must provide consent to a processing purpose. In these cases, the user might need to tick an unticked box. However, for the general information (e.g., contact data of the data privacy officer and data subject rights), this may not be explicitly required. This disparity of requirements leads to the problem that data privacy statements are often uploaded to some location and an application/tool used by the data subject contains a link to that location. However, this approach might not fulfill all legal requirements, as the server/application that contains the privacy statement (e.g., a group in a social network or another server) might be down in general or the user might not have enough authorizations to view the privacy statement. For a data controller in this scenario, it may not be possible with reasonable effort to prove, that a data subject has access to the privacy statement if that statement is located somewhere else on different servers or within different applications. In addition to that, it might not be possible to prove that a privacy statement is linked from specific places within an application at any time. Similar considerations may arise with respect to other scenarios in which a different type of service provider (e.g., an online merchant, web application provider, software provider, etc.) attempts to track user accessibility to and/or acceptance of other information statements (e.g., terms of service documents).

The following description provides some example approaches to overcome the technical problems and/or disadvantages described above. As used herein, information statement may refer to any information, such as a privacy statement, terms and conditions statement, etc., that a service provider, such as a data controller (e.g., defined in accordance with Article 4 of the GDPR), an online merchant, a web application provider, a software provider, etc., would like to provide to a user in a manner that allows for tracking whether the information was made available to the user and/or for tracking a timing at which the information was made available to the user. As used herein, a user may include a data subject and/or a user attempting to access an asset of the service provider (e.g., a web page, an online store, a web application, a software application, and/or other asset). The information statement may have any suitable format for presenting information to a user. In one example, the service provider may provide the information statement in coordination with a web browser addon, a manipulated (e.g., modified) and/or forked version of the browser (e.g., the addon may be made a part of the browser by forking the browser), or other software installed at a user device of a user accessing a web page or other asset (e.g., user-accessible application as described above) of the service provider. The browser addon, manipulated/forked browser, or other software may manipulate a document object model (DOM) of the displayed web page (e.g., the DOM is the structure of the Hypertext Markup Language (HTML) code of the web page that is shown in the browser) or other asset in a way that a link to the information statement is always visible on the screen in a user-configured way (e.g., in a configured location, such as the top left corner, central in the footer, etc.). When the user accesses a server of the service provider (e.g., to send a Hypertext Transfer Protocol (HTTP) request to access the web page), the server sends via a special http header field a link to the information statement, and the header field is evaluated by the browser addon, manipulated/forked browser, or other software.

The information statement may be shown to the user when the user selects the link at the configured location. However, if the server does not send any information statement (e.g., the examination of the header field indicates that the header field is empty, the information statement is not available/empty, etc.), the browser addon or other software may block access to the web page or other asset in a configurable manner. In some examples, when access is blocked, the browser addon or other software may call a predetermined URL to notify the service provider and/or an associated data privacy/control officer about the issue. This reporting may be performed in an anonymous way for increased privacy for the user.

If the information statement is received by the browser addon or other software, the browser addon or other software may sign the full information statement document with a private key associated with the user and send the signature to the service provider. In this way, the service provider may have proof that the user was provided the information statement. The document including the signature may include information about a date, time, and any data subject identifier. If the information statement is provided via the link in the header field (e.g., transferred to a web browser or other application executing on the user device) but not opened by the user, an indication of such an occurrence may be highlighted (e.g., with a different color coding in the DOM tree). Similarly, a highlighting operation may be performed if a new version of the information statement is provided to the browser addon or other software after the original version of the information statement is provided to the user. In this way, the user may be notified when the information statement has changed. In such an example, the viewing of the new version of the information statement by the user may be reported as described above via a new signature. In some examples, the browser addon or other software may generate for display (e.g., responsive to a selection of a corresponding user interface menu option) a historical record of privacy statements that apply to applications that the user has accessed.

In this way, the service provider can prove that data subjects can access certain information when accessing web applications. The service provider has all data to prove accessibility to information statements, including identifying which data subject had access to which information statement, and identifying a time at which each data subject was provided access to each corresponding information statement. With the DOM tree manipulation, it is ensured that the information statement is consistently linked at a place that is convenient for the data subject. The data subject has the benefit that he/she can always access the privacy statement and will not get problems with “no authorization” or similar. Additional features (e.g. highlighting new privacy statement/terms and conditions versions) are further convenience features improving the user's experience with the service provider's software. The use of an addon or other software may provide benefits for cloud-based implementations of the service provider's software, since the above-described features may be adopted to multiple cloud-based products of the service provider to provide a consistent experience for the user across the portfolio of products of the service provider. Further, as users of cloud-based products may sign into the products using a user identifier, the user identifier may be used in the above-described signature to increase user friendliness of accessing the information statements in a trackable manner.

### First Example Method

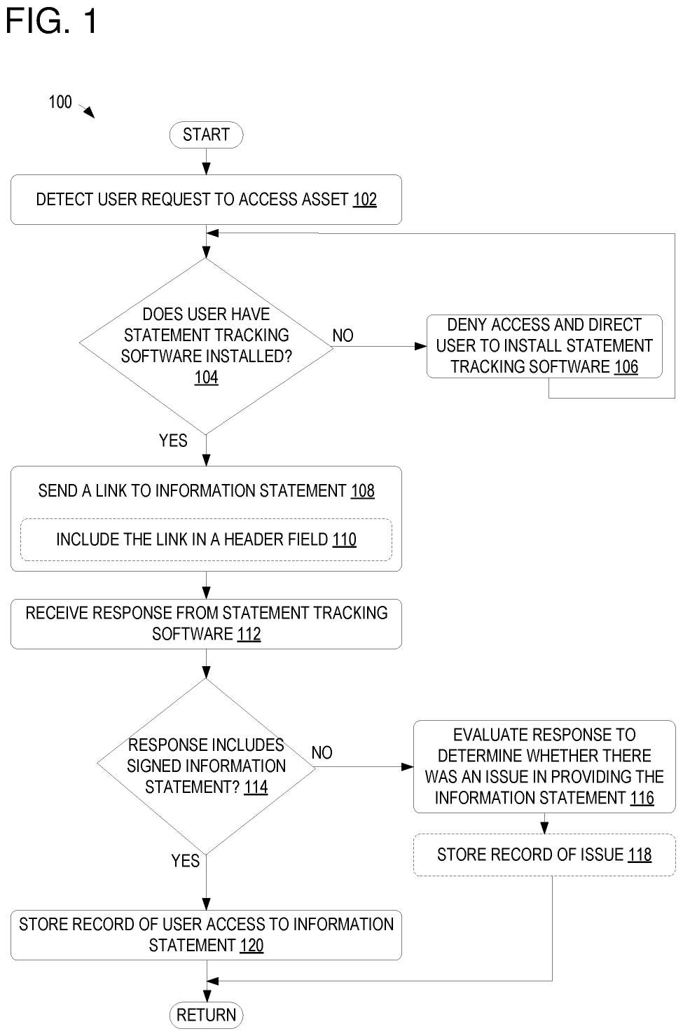

FIG. 1 is a flowchart 100 of an example method for controlling and tracking provision on information statements to users. At 102, the method includes detecting a user request to access an asset of a service provider. For example, the asset may be a webpage hosted by the service provider, which may collect user information while the user accesses the webpage. In other examples, the asset may be an application or other software that provides user data to the service provider and/or is otherwise associated with the service provider.

At 104, the method includes determining if the user has statement tracking software installed. The statement tracking software may be in the form of a web browser addon or a standalone software application (e.g., which may include a modified version of a web browser, such as the manipulated/forked version described above) that is configured to interact with a web browser or other application associated with the asset to which the user is requesting access.

If the user does not have statement tracking software installed (e.g., “NO” at 104), the method proceeds to 106 to deny access and direct the user to install statement tracking software.

The method may then return to 104 to allow the user to proceed once the statement tracking software is installed.

If the user does have statement tracking software installed (e.g., “YES” at 104), the method proceeds to 108 to send a link to an information statement to the user device (e.g., for processing by the tracking software). As indicated at 110, the link may be included in a header field, for example, a header field of an http document. It is to be understood that in some examples, the statement tracking software check at 104 may be optional and/or indirectly performed. For example, the service provider may be configured to infer that the tracking software is installed responsive to receiving a request for the information statement and may send the link at 108 responsive to the request.

At 112, the method includes receiving a response from the statement tracking software. The response is evaluated and at 114, the method includes determining whether the response includes a signed information statement (e.g., a signature corresponding to the full information statement linked to by the link sent at 108). If the response does not include the signed information statement or if the signature is invalid (e.g., “NO” at 114), the method proceeds to 116 to evaluate the response to determine whether there was an issue in providing the information statement. The method further optionally includes storing a record of the issue if identified.

If the response includes a signed information statement (e.g., “YES” at 114), the method proceeds to 120 to store a record of the user access to the information statement. The record may include a user identifier, a time/date of access, and/or other information, at least a subset of which may be included in the signature received in the response at 112. If the requested access to the service provider asset involves a transmission of data to the user device for use of the asset, the service provider may be configured to transmit the data responsive to a determination of receipt of the signed information statement at 114 and to deny transmission of the data responsive to a determination of receipt of no response or receipt of a response that does not include the signed information statement at 114.

### Second Example Method

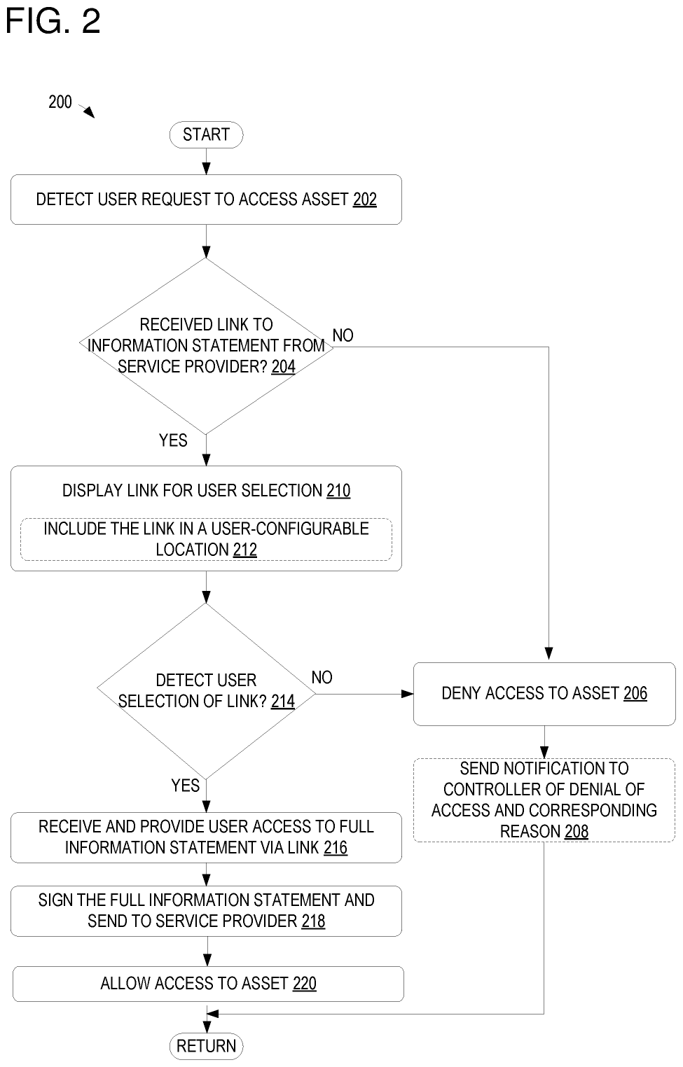

FIG. 2 shows an example portion of a user interface 200, which may be performed by a statement tracking software. At 202, the method includes detecting a user request to access an asset of a service provider. For example, the controller asset may be a webpage hosted by the service provider or, in examples where the service provider is a data controller, a processor as defined in Article 4 of the GDPR (e.g., a natural or legal person, public authority, agency or other body which processes personal data on behalf of the controller), which may collect user information while the user accesses the webpage. In other examples, the asset may be an application or other software that provides user data to the service provider and/or is otherwise associated with the service provider.

At 204, the method includes determining if a link to an information statement is received from the service provider. For example, a header field of information received from the service provider may be evaluated to determine if a link to an information statement is present. If a link is not received (e.g., “NO” at 204), the method proceeds to 206 to deny access to the asset and optionally to 208 to send a notification of the denial and corresponding reason for denial to the service provider. It is to be understood that denying access to the asset may include denying access to a portion of the asset. For example, operations of the asset that do not result in the collection of personal data of the user may be permitted, while operations of the asset that collect personal data may not be permitted responsive to a denial of access at 206. In other examples, operations that are not affected by and/or are not otherwise associated with the information statement (e.g., a terms and conditions document) may be permitted, while operations that are affected by and/or otherwise associated with the information statement may not be permitted responsive to a denial of access at 206. In this way, responsive to the denial of access at 206, the functionality and/or content associated with the asset that is made available to the user may be fully or partially suppressed (e.g., until the information statement can be proven to be provided to the user, as described below). When access to the asset is denied or blocked, the service provider and/or an associated data privacy/control officer may be notified (e.g., via a call to a predetermined URL) about the issue. This reporting may be anonymous, for example, the reporting may not identify the user device and/or an associated user requesting access to the service provider asset. The reporting may include additional information, such as an imprint of the website or other information that may indicate a reason/cause of the denial of access and/or otherwise be useful for record keeping.

If a link to the information statement is received (e.g., “YES” at 204), the method includes displaying the link for user selection, as indicated at 210. The link may be presented in a user-configurable location, as indicated at 212. For example, the statement tracking software may include user-configurable settings, which may include settings for a placement of information statement links. In this way, the information statement may be presented to the user in a consistent location of the user interface associated with the asset (e.g., the web browser, the service provider's application being executed on the user's device, etc.).

At 214, the method includes determining if a user selection of the link is detected. If selection of the link is not detected (e.g., “NO” at 214), the method proceeds to 206 to deny access to the asset as described above, and optionally to send a corresponding notification of the access denial to the service provider, as indicated at 208.

If selection of the link is detected (e.g., “YES” at 214), the method proceeds to 216 to receive and provide user access to the full information statement via traversal of the link. For example, the full information statement may be presented via the browser and/or application used to access the asset. Parameters of the presentation of the full information statement, such as a presentation mechanism (e.g., via a display, via audio output, etc.), a presentation location (e.g., via a separate user interface window, via the browser or application used to access the asset, etc.), and/or other parameters may be user-configurable in some examples. At 218, the method includes, responsive to providing the user access to the full information statement, signing the full information statement and sending the signed statement to the service provider for the service provider's records. The statement may be cryptographically signed with a private key, which may be owned or otherwise held by the user and/or user device. The signed statement may also indicate a time and/or date that the information statement was presented to the user. For example, a user identifier and/or a timestamp may be sent in addition to the signed statement. The user identifier and/or the timestamp may also be signed (e.g., with the same private key used to sign the information statement). The signing of data may be used to enable the service provider to verify that the data is received from the user (e.g., using public key cryptography mechanisms). An example signing process may include generating a signature by signing the information statement, the user identifier, and the timestamp with a private key, and sending the information statement, user identifier, and timestamp with the signature to the service provider (optionally applying encryption, for example to encrypt the information statement, user identifier, and timestamp).

In some examples, the provision of user access may be sufficient to trigger the signing of the full information statement. In other examples, the signing of the full information statement may occur responsive to detectable presentation of all or a portion of the full information statement and/or a detection of user interaction with the full information statement.

In some examples, the signing of the full information statement may be performed automatically, using stored data associated with the user. In other examples, the signing of the full information statement may be performed based on the receipt of user identification and/or authentication data from the user. An indication of the user's interaction with the information statement may be provided in the signed full information statement to assist the service provider in tracking the user access to the information statement.

At 220, the method includes allowing access to the asset. For example, the operations and/or content that are described as being suppressed or not permitted when denying access to the service provider at 206 may be enabled and/or presented to the user to allow access to the asset at 220. In this way, access to the asset may only be allowed responsive to providing the user access to the information statement, and access to the asset may be denied until the access to the information statement is provided and/or proof of the access to the information statement is sent to the service provider. In some examples, allowing access to the asset may include allowing user personal data and/or interaction data to be sent to the service provider and/or allowing data from the service provider corresponding to the asset to be sent the user device and/or presented to the user.

### Example Configurations

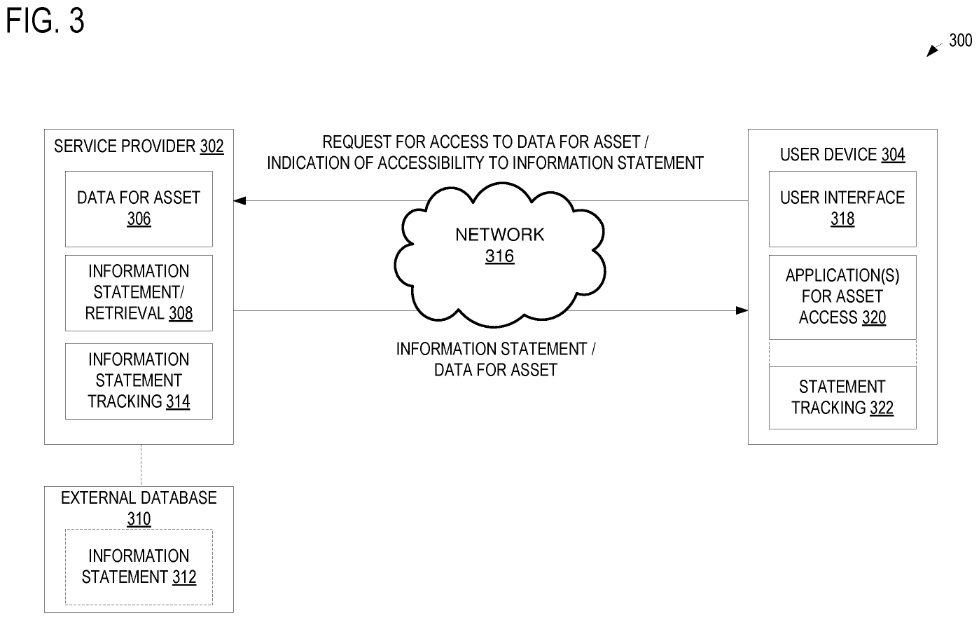

FIG. 3 shows an illustrative example of an information tracking system 300 including a service provider 302 and a user device 304. In some examples, the service provider 302 may be configured to perform the method 100 of FIG. 1. In additional examples, the user device 304 may be configured to perform the method 200 of FIG. 2.

The service provider 302 may include data for an asset 306, such as a website, a client application, and/or other user-accessible content. The service provider 302 may also include an information statement storage and/or retrieval component 308 corresponding to an information statement associated with the asset. In some examples, the information statement storage and/or retrieval component 308 may include a data storage device that stores and/or maintains information statements for the asset locally at the service provider. In other examples, one or more information statements for the asset may be stored remotely, such as in external database 310, illustrated as storing information statements 312. In such examples, information statement storage/retrieval component 308 may include a control module configured to manage retrieval of information statements from the external database 310.

The service provider 302 may also include an information statement tracking component 314 configured to manage information regarding the dispersion of information statements to users requesting access to the asset and the interaction of users with the information statements. Although depicted as a single device, it is to be understood that service provider 302 may correspond to a distributed, cloud-based computing system and/or may otherwise include a plurality of computing devices. As a non-limiting example, the data for the asset 306 may be included in one or more servers associated with the service provider, while the remaining components are included in a centralized control device of the service provider.

The user device 304 may be communicatively connected to the service provider 302 via a network 316. It is to be understood that both the user device 304 and the service provider 302 may respectfully include one or more communication interfaces configured to control and provide for communication between the user device and service provider (e.g., via the network). The user device 304 may include a user interface 318 to enable user interaction with the user device. For example, the user interface may be coupled to one or more input and/or output devices to control interaction between the user and the user device.

The user device may further include one or more applications for asset access 320. In examples where the asset corresponds to content and/or an application accessible via a webpage, the applications 320 may include a web browser. In examples where the asset corresponds to an application or other software executable on a user device, the applications 320 may include that application or other software. In the above examples, the applications 320 may provide for interaction with service provider assets that are associated with an information statement and subject to regulations regarding provision of access to the assets based on availability of the information statement for the user.

The user device may further include a statement tracking module 322, which may be an addon component (e.g., a browser addon) associated with the applications 320 and/or a separate, standalone executable application configured to interact with the applications 320. The statement tracking module 322 may control distribution of information statements to the user and access of the user to functionality and/or content of the service provider access via the applications 320.

In an example operation, a user may launch, via the user interface 318, one of applications 320 in order to access a service provider asset, such as a webpage associated with the service provider and/or the application 320 itself. The statement tracking module 322 may detect the attempt to access the service provider asset (e.g., the launching of the application and/or the navigation to a webpage associated with the service provider) and prevent the applications 320 from allowing full access to the service provider asset. The statement tracking module 322 may also submit a request to the service provider for access to the asset.

Responsive to receipt of the request, the information statement storage and/or retrieval component 308 may identify an information statement associated with the request (e.g., associated with the asset that the user is attempting to access, which may be identified in the request). The information statement storage and/or retrieval component 308 may retrieve the identified information statement (e.g., from local storage and/or from the external database 310) and transmit the retrieved information statement to the user device 302. In some examples, the information statement and/or retrieval component may transmit a link to the information statement (e.g., a link to the local storage and/or a link to the information statement 312 located in the external database 310) in response to the initial request.

The statement tracking module 322 may receive the information statement and/or link and present the information statement and/or link for the user. For example, the link may be displayed in a user-configurable location of the application 320 used to attempt to access the asset (e.g., a location in the web browser or a location in the application associated with the asset). In other examples, the link may be presented as a pop-up window or other overlay of a graphical user interface presented via the user device 304.

The statement tracking module 322 may transmit to the service provider 302 an indication of accessibility to the information statement. For example, if a link is initially provided, the statement tracking module may transmit, responsive to user selection of the link, an indication that the user selected the link and a request for the full information statement. In response to receiving (e.g., from the service provider and/or from another computing system hosting the information statement) and making the information statement available for user consumption (e.g., displaying, via the user interface, the full information statement), the statement tracking module 322 may send a notification to the service provider 302 indicating that the full information statement was made available to the user. The notification may include a signed version of the full information statement and/or another communication that includes an identification of the information statement, the user to which the information statement was provided, and the time at which the information statement was provided to the user (or the time at which the notification was transmitted). The statement tracking module 322 may also enable access to the asset (e.g., allowing the application 320 to resume functionality and/or request data associated with the asset).

The information statement tracking component 314 of the service provider may receive the above-described notification and store data from the notification in order to maintain a historical record of information statements that have been made available to users. For example, the information statement tracking component 314 may store an identifier of the information statement, the user, and the time as included in the notification described above. In examples where the user is able to interact with the information statement (e.g., providing input to sign the information statement or select an option associated with the information statement), an indication of the interaction (e.g., including the identity of the user and the user input directed to the information statement, such as the signature or selected options) may be transmitted via the user-side statement tracking module 322 and stored/maintained via the service provider-side information statement tracking component 314.

In examples where there is an issue with the accessibility of the information statement (e.g., the link is not received at the user device, the full information statement is not received at the user device, the full information statement is not presented to the user, the user does not interact with the full information statement, etc.), the indication of accessibility may include an indication of the issue, which may include the type of accessibility deficiency (e.g., which of the above example issues were experienced), a time at which the issue was identified, and a user associated with the asset access request. In response, the information statement tracking component 314 may store data from the indication and optionally trigger output of a warning to an operator of the service provider to enable the operator to address the issue.

As both parties (e.g., the service provider and the user device) are informed of issues with presenting the information statement, the control of access to the asset may be implemented on either or both of the user device and the service provider. For example, prior to receiving a positive identification that the information statement was made available to the user, the user-side statement tracking module 322 may control functionality of the application 320 to prevent access to the asset on the user-side, while the service provider-side information tracking component 314 may control the transmission of the data for the asset 306 to prevent unapproved transmission of the data on the service provider-side.

### Example Use Cases

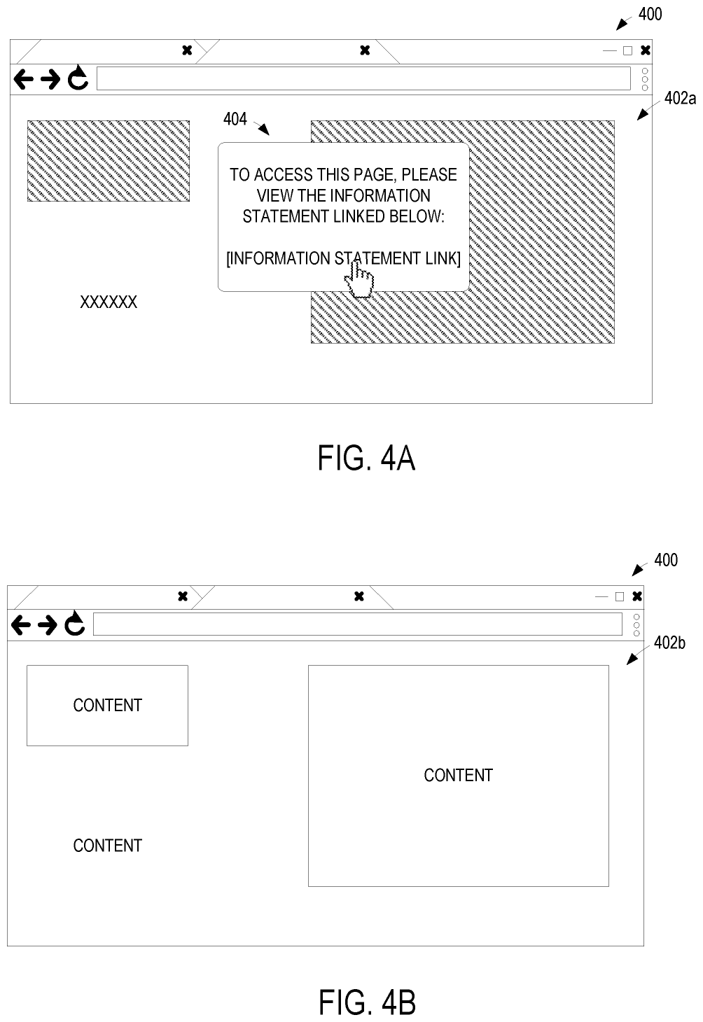

FIGS. 4A and 4B show example states of a user interface for accessing a data controller asset via an application 400 of a user device. In the illustrated example, the application 400 is a web browser, however, it is to be understood that the application may be any application usable to access a data controller asset in other examples. In FIG. 4A, the user interface 402a shows a first state of operation of the application 400, which may correspond to a first time a user has attempted to access the data controller asset (in the illustrated example, a web page or web-based application managed by the data controller) or a first time the user has attempted to access the data controller asset since a latest update of an information statement associated with the asset (described in more detail below). In the state of the user interface 402a, access to the asset is at least partially denied by adjusting functionality of the application 400 (e.g., using a statement tracking module, such as statement tracking module 322 of FIG. 3) to display an altered version of the webpage (e.g., with an obfuscation of content). The adjustment of functionality of the application 400 may also include reducing or eliminating the ability for the application to send personal data of a user to the data controller while in the illustrated state. In some examples, the application 400 may be adjusted to not display any content relating to the asset (e.g., the obfuscated elements, represented by hashed content boxes and obscured text string “XXXXXX,” may be completely removed). The statement tracking module may also control the display of a statement access window 404 that includes a link to an information statement.

It is to be understood that different adjustments of functionality may be made for different use cases (e.g., where different service provider entities and/or information statements are involved). In some examples, such as data protection scenarios in which a data controller attempts to provide an information statement such as a privacy statement for access by a data subject, the adjustment of functionality may include preventing and/or prohibiting the processing (which may include collection, modification, and/or storage) of personal data (e.g., IP addresses, cookie IDs, etc.) and/or preventing and/or prohibiting the data subject from accessing an asset of the data controller, such as a webpage and/or an application (e.g., a Software as a Service application), until the privacy statement is made accessible by the data subject in a trackable manner. For example, the user may be prohibited from performing interactions with the asset that cause personal data for the user to be sent to the data controller, and/or the data controller may be prohibited from collecting and/or storing personal data, as the user may not be able to control the transmission of some personal data (e.g., IP addresses) during attempts to interact with the asset. In other examples, in which the information statement corresponds to terms of services provided by a service provider such as an online merchant, the adjustment of functionality may include preventing selected transactions, disabling selected user interface elements, issuing notifications, etc., until the terms of services are made accessible by the data subject/user and/or signed/accepted by the data subject/user (e.g., via a browser addon, modified browser, and/or other software application as described above). For example, a “create new order” step for an online store may be disabled for the user, or the user may be presented a notification that due to technical issues new orders cannot be submitted, but pre-orders can be submitted that must be confirmed after the technical issue is solved. It is to be further understood that the above-described adjustments of functionality may be used in any suitable combination for a given use case.

FIG. 4B shows a user interface 402b corresponding to a state that occurs after the user has selected the link in statement access window 404 of FIG. 4A and is presented with the information statement. Responsive to presentation of the information statement to the user, the functionality of the application may be further adjusted to allow the content of the data controller asset (e.g., content of the webpage) to be displayed in an unaltered format. In some examples, the content used to populate the user interface 402b may be retrieved responsive to the statement tracking module sending a confirmation of user access to the information statement (e.g., the signed information statement as described above with respect to FIG. 2). On a subsequent visit by the user to the webpage, the user interface 402b may be shown unless an updated version of the information statement is available (which would result in the interface 402a being shown with a link to the updated information statement—in such an example, the link may be highlighted to indicated that it corresponds to an updated statement). As described above, for different use cases, the further adjustment of functionality may correspond to different actions, such as the enabling of collection of personal data and access to assets in a data protection example, and/or access to increased options/transactions for an online store in a terms of services example.

### A Generalized Computer Environment

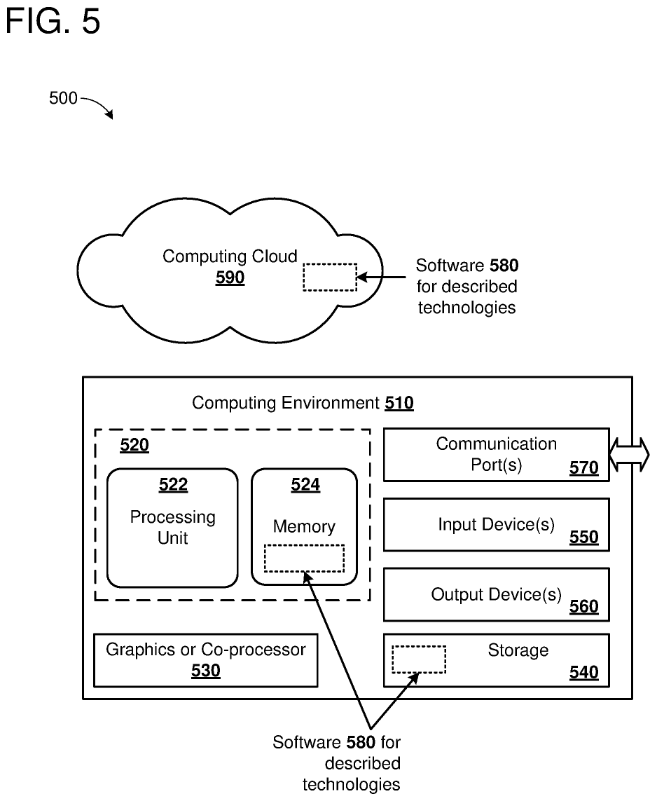

FIG. 5 illustrates a generalized example of a suitable computing system 500 in which described examples, techniques, and technologies, including construction, deployment, operation, query processing, and maintenance of a composite graph data structure or dynamic rooted trees according to disclosed technologies can be implemented. The computing system 500 is not intended to suggest any limitation as to scope of use or functionality of the present disclosure, as the innovations can be implemented in diverse general-purpose or special-purpose computing systems.

With reference to FIG. 5, computing environment 510 includes one or more processing units 522 and memory 524. In FIG. 5, this basic configuration 520 is included within a dashed line. Processing unit 522 executes computer-executable instructions, such as for implementing any of the methods or objects described herein for performing queries on a composite graph data structure representing a dynamic system, or various other architectures, components, handlers, managers, modules, or services described herein. Processing unit 522 can be a general-purpose central processing unit (CPU), a processor in an application-specific integrated circuit (ASIC), or any other type of processor. In a multi-processing system, multiple processing units execute computer-executable instructions to increase processing power. Computing environment 510 can also include a graphics processing unit or co-processing unit 530. Tangible memory 524 can be volatile memory (e.g., registers, cache, or RAM), non-volatile memory (e.g., ROM, EEPROM, or flash memory), or some combination thereof, accessible by processing units 522, 530. The memory 524 stores software 580 implementing one or more innovations described herein, in the form of computer-executable instructions suitable for execution by the processing unit(s) 522, 530. The memory 524 can also store a composite graph data structure, including nodes, edges, and their respective attributes; a table or other data structure indicating states of a modeled system, configuration data, UI displays, browser code, data structures including data tables, working tables, change logs, output structures, input fields, output fields, data values, indices, or flags, as well as other operational data.

A computing system 510 can have additional features, such as one or more of storage 540, input devices 550, output devices 560, or communication ports 570. An interconnection mechanism (not shown) such as a bus, controller, or network interconnects the components of the computing environment 510. Typically, operating system software (not shown) provides an operating environment for other software executing in the computing environment 510, and coordinates activities of the components of the computing environment 510.

The tangible storage 540 can be removable or non-removable, and includes magnetic disks, magnetic tapes or cassettes, CD-ROMs, DVDs, or any other medium which can be used to store information in a non-transitory way and which can be accessed within the computing environment 510. The storage 540 stores instructions of the software 580 (including instructions and/or data) implementing one or more innovations described herein.

The input device(s) 550 can be a mechanical, touch-sensing, or proximity-sensing input device such as a keyboard, mouse, pen, touchscreen, trackball, a voice input device, a scanning device, or another device that provides input to the computing environment 510. The output device(s) 560 can be a display, printer, speaker, optical disk writer, or another device that provides output from the computing environment 510.

The communication port(s) 570 enable communication over a communication medium to another computing device. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, acoustic, or other carrier.

In some examples, computer system 500 can also include a computing cloud 590 in which instructions implementing all or a portion of the disclosed technology are executed. Any combination of memory 524, storage 540, and computing cloud 590 can be used to store software instructions and data of the disclosed technologies.

The present innovations can be described in the general context of computer-executable instructions, such as those included in program modules, being executed in a computing system on a target real or virtual processor. Generally, program modules or components include routines, programs, libraries, software objects, classes, components, data structures, etc. that perform tasks or implement particular abstract data types. The functionality of the program modules can be combined or split between program modules as desired in various embodiments. Computer-executable instructions for program modules can be executed within a local or distributed computing system.

The terms “system,” “environment,” and “device” are used interchangeably herein. Unless the context clearly indicates otherwise, none of these terms implies any limitation on a type of computing system, computing environment, or computing device. In general, a computing system, computing environment, or computing device can be local or distributed, and can include any combination of special-purpose hardware and/or general-purpose hardware and/or virtualized hardware, together with software implementing the functionality described herein. Virtual processors, virtual hardware, and virtualized devices are ultimately embodied in a hardware processor or another form of physical computer hardware, and thus include both software associated with virtualization and underlying hardware.

### Example Cloud Computing Environment

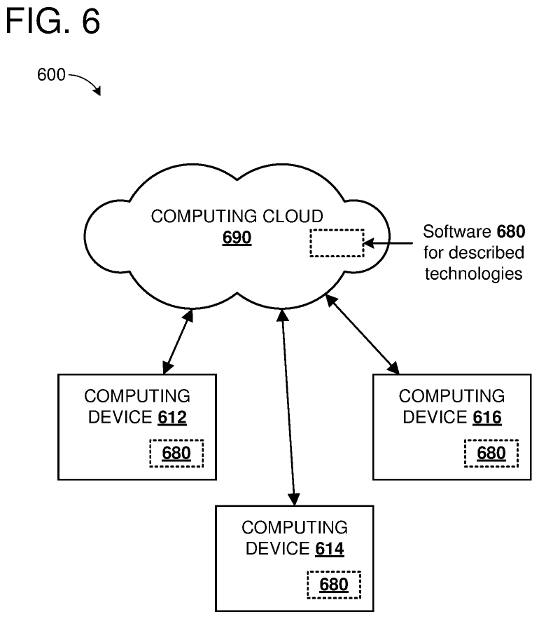

FIG. 6 depicts an example cloud computing environment 600 in which the described technologies can be implemented. The cloud computing environment 600 comprises a computing cloud 690 containing resources and providing services. The computing cloud 690 can comprise various types of cloud computing resources, such as computer servers, data storage repositories, networking resources, and so forth. The computing cloud 690 can be centrally located (e.g., provided by a data center of a business or organization) or distributed (e.g., provided by various computing resources located at different locations, such as different data centers and/or located in different cities or countries). It is to be understood that the example cloud computing environment 600 is one example environment in which the described technologies can be implemented, and other environments may be used in addition or alternatively to the example cloud computing environment. For example, the described technologies may be implemented on peer-to-peer networks and/or in coordination with a blockchain storage mechanism.

The computing cloud 690 can be operatively connected to various types of computing devices (e.g., client computing devices), such as computing devices 612, 614, and 616, and can provide a range of computing services thereto. One or more of computing devices 612, 614, and 616 can be computers (e.g., servers, virtual machines, embedded systems, desktop, or laptop computers), mobile devices (e.g., tablet computers, smartphones, or wearable appliances), or other types of computing devices. Communication links between computing cloud 690 and computing devices 612, 614, and 616 can be over wired, wireless, or optical links, or any combination thereof, and can be short-lived or long-lasting. Communication links can be continuous or sporadic. These communication links can be stationary or can move over time, being implemented over varying paths and having varying attachment points at each end. Computing devices 612, 614, and 616 can also be connected to each other.

Computing devices 612, 614, and 616 can utilize the computing cloud 690 to obtain computing services and perform computing operations (e.g., data processing, data storage, and the like). Particularly, software 680 for performing the described innovative technologies can be resident or executed in the computing cloud 690, in computing devices 612, 614, and 616, or in a distributed combination of cloud and computing devices.

### General Considerations

As used in this disclosure, the singular forms “a,” “an,” and “the” include the plural forms unless the surrounding language clearly dictates otherwise. Additionally, the terms “includes” and “incorporates” mean “comprises.” Further, the terms “coupled” or “attached” encompass mechanical, electrical, magnetic, optical, as well as other practical ways of coupling items together, and does not exclude the presence of intermediate elements between the coupled items. Furthermore, as used herein, the terms “or” and “and/or” mean any one item or combination of items in the phrase.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smartphones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 5, computer-readable storage media include memory 524, and storage 540. The term computer-readable storage media does not include signals and carrier waves. In addition, the term computer-readable storage media does not include communication ports (e.g., 570) or communication media.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in ABAP, Adobe Flash, Angular, Basic, C, C++, C#, Curl, Dart, Fortran, Go, Java, JavaScript, Julia, Lisp, Matlab, Octave, Pascal, Perl, PHP, Python, R, Ruby, SAS, SPSS, Visual Basic, WebAssembly, Whitespace, any derivatives thereof, or any other suitable programming language, or, in some examples, markup languages such as HTML or XML, or in any combination of suitable languages, libraries, and packages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-implemented method comprising:
receiving a request from a user device to access an asset of a service provider through an application of the user device;
sending, to a statement tracking module of the user device, data corresponding to an information statement associated with the asset;
receiving, from the statement tracking module of the user device, a response including an indication of user accessibility to the information statement;
storing the response from the statement tracking module; and
selectively allowing access to the asset through the application of the user device based on the response, wherein the access to the asset is allowed responsive to the response including signed data, the signed data including the information statement, a user identifier, and a timestamp.

2. The computer-implemented method of claim 1, wherein the service provider asset includes a web page, the application of the user device comprises a web browser, and the statement tracking module comprises an addon for the web browser, a modified version of the web browser, or a standalone application executed on the user device.

3. The computer-implemented method of claim 2, wherein the request from the user device comprises a Hypertext Transfer Protocol (HTTP) request, and wherein the data corresponding to the information statement includes a link to the information statement.

4. The computer-implemented method of claim 3, wherein the link is included in an HTTP header field.

5. The computer-implemented method of claim 1, wherein selectively allowing access to the asset includes denying access to the asset responsive to the response including a notification of an issue preventing user accessibility to the information statement.

6. The computer-implemented method of claim 5, wherein the notification is an anonymous notification that does not identify the user device or does not identify a user of the user device requesting access to the asset.

7. The computer-implemented method of claim 1, wherein the data corresponding to the information statement includes a full version of the information statement.

8. The computer-implemented method of claim 1, wherein the information statement included in the signed data comprises a full version of the information statement that is cryptographically signed using a private key that is owned by the user identified by the user identifier.

9. The computer-implemented method of claim 1, wherein the information statement comprises a privacy statement or a notification of terms and conditions associated with the asset.

10. One or more computer-readable media storing instructions which, when executed by one or more hardware processors, cause the hardware processors to perform actions comprising:
detecting a user request to access an asset of a service provider via an application of a user device;
determining whether an information statement associated with the asset is accessible by the user;
during a first condition in which the information statement is determined to be accessible by the user, sending a first notification to the service provider and allowing access to the asset via the application of the user device, the first notification including a signed information statement, a user identifier for a user requesting to access the asset, and a timestamp; and
during a second condition, in which the information statement is determined to not be accessible by the user, sending a second notification to the service provider and denying access to the asset via the application of the user device, the second notification including an indication of an issue with user accessibility to the information statement.

11. The one or more computer-readable media of claim 10, wherein the actions further comprise generating the signed information statement by signing the information statement using a private key owned by the user requesting the access the asset.

12. The one or more computer-readable media of claim 10, wherein denying access to the asset includes suppressing at least a portion of a functionality of the application.

13. The one or more computer-readable media of claim 10, wherein the asset includes a webpage managed by the service provider and wherein denying access to the asset includes altering or prohibiting display of content for the webpage.

14. The one or more computer-readable media of claim 10, wherein denying access to the asset includes prohibiting interactions with the asset that cause personal data for the user to be sent to the service provider.

15. The one or more computer-readable media of claim 10, wherein denying access to the asset further includes prohibiting the service provider from collecting personal data for the user.

16. The one or more computer-readable media of claim 10, wherein determining whether an information statement associated with the asset is accessible by the user comprises determining whether a link to the information statement is received from the service provider and determining whether the information statement is retrieved from the link.

17. A system comprising:
one or more hardware processors with memory coupled thereto;
computer-readable media storing instructions executable by the one or more hardware processors, the instructions comprising:
first instructions to receive data from a service provider corresponding to an asset of the service provider that is selectively accessible via an application of a user device;
second instructions to adjust functionality of the application to deny access to the asset until an information statement is provided for access by a user of the user device;
third instructions to determine whether the data includes a link to an information statement associated with the asset;
fourth instructions to maintain the adjusted functionality of the application to deny access to the asset under a first condition in which the data is determined to not include the link;
fifth instructions to present the link to the user under a second condition in which the data is determined to include the link;
sixth instructions to retrieve, via the link, and present the information statement under the second condition responsive to detecting a selection of the link;
seventh instructions to sign the information statement and send the signed information statement to the service provider under the second condition; and
eighth instructions to further adjust the functionality of the application to allow access of the asset responsive to sending the signed information statement to the service provider under the second condition.

18. The system of claim 17, wherein the link is displayed in a user-configurable location in the application.

19. The system of claim 17, wherein signing the information statement includes cryptographically signing the information statement with a private key owned by the user, wherein sending the signed information statement further includes sending a user identifier of a user requesting access to the asset and a timestamp associated with the presentation of the information statement, and wherein the user identifier and the timestamp are signed using the private key owned by the user.

20. The system of claim 17, further comprising ninth instructions to send a notification to the service provider of a denial of access to the asset under the first condition.
